(19) United States
(12) Patent Application Publication
(10) Pub. No.: US 2024/0413708 A1
(43) Pub. Date: Dec. 12, 2024

(54) MATRIX MOTOR UNIT STRUCTURE AND MATRIX MOTOR

(71) Applicant: SHENZHEN INSTITUTES OF ADVANCED TECHNOLOGY, Shenzhen (CN)

(72) Inventor: Tianfu SUN, Shenzhen (CN)

(73) Assignee: SHENZHEN INSTITUTES OF ADVANCED TECHNOLOGY, Shenzhen (CN)

(21) Appl. No.: 18/811,524

(22) Filed: Aug. 21, 2024

Related U.S. Application Data
(63) Continuation of application No. PCT/CN2022/142901, filed on Dec. 28, 2022.

(30) Foreign Application Priority Data
May 16, 2022 (CN) 202210530809X

(51) Int. Cl. H02K 7/20; H02K 1/14; H02K 1/16; H02K 3/28

(52) U.S. Cl. CPC H02K 7/20; H02K 1/146; H02K 1/16; H02K 3/28; H02K 2201/15; H02K 2213/12

(57) ABSTRACT

The present application relates to the technical field of motors, and provides a matrix motor unit structure and a matrix motor. The matrix motor unit comprises at least two motor elements, and the motor elements are connected in an array form in a same plane and defined a motor main body structure. According to the matrix motor unit structure provided by the present application, the motor elements are compactly arranged, and a structure can be shared among the motor elements, so that the overall size and weight can be further reduced, and a higher output torque is obtained.

### CROSS-REFERENCE TO RELATED APPLICATIONS

The present application claims priority to Chinese Patent Application No. 202210530809. X entitled “MATRIX MOTOR UNIT STRUCTURE AND MATRIX MOTOR” filed with China National Intellectual Property Administration on May 16, 2022, which is incorporated herein by reference in its entirety.

### TECHNICAL FIELD

The present application relates to the technical field of motors, and particularly provides a matrix motor unit and a matrix motor with the matrix motor unit structure.

### BACKGROUND

The motor is composed of a stator and a rotor. Stator slots are formed in the stator and windings are wound around the stator slots. By introducing currents into the windings of the stator, the stator generates a rotating magnetic flux vector, which attracts the rotor to rotate, and finally, an output torque of the motor is achieved.

One of the most important indicators of motor performance is the torque density of the motor, which is equal to a ratio of the torque of the motor to the size of the motor, or a ratio of the torque of the motor to the weight of the motor. Therefore, the output torque of the motor can be increased by increasing the torque density. The usual measure is to add permanent magnets to the rotor, or to increase the number of poles of the rotor, or to increase the current introduced into the windings. However, the limited space available in the stator slots, the existence of an upper limit on the magnetic permeability of the stator and rotor, and the tendency to burn out the stator if the current is too high limit the increase in the torque density of the motor.

In other embodiments, there are ways of connecting two or more motors by means of a transmission mechanism to increase the total output torque of the motors, however, this increases the overall size and weight of the motor system.

### SUMMARY

The purpose of embodiments of the present application is to provide a matrix motor unit structure, aiming to solve the problem that the output torques of existing motors are limited to be increased.

In order to achieve the above purpose, the embodiments of the present application adopts the following technical solutions:

In a first aspect, the embodiments of the present application provide a matrix motor unit structure, which includes at least two motor elements. The motor elements are connected in an array in a same plane and form a motor main body structure by enclosure, so that central axes of torque output shafts of the motor elements are symmetric with respect to a geometric center of the motor main body structure.

The embodiments of the present application have the following beneficial effects: Provided is a matrix motor unit structure according to the present application, which includes two or more motor elements. In this case, the motor elements are connected in an array in a same plane to form a motor main body structure. The motor main body structure has a geometric center, that is, the contour of the motor main body structure is symmetrical, so that central axes of torque output shafts of the motor elements are symmetrical with respect to the geometric center of the motor main body structure. Alternatively, in the case that the central axis of the torque output shaft of one of the motor elements coincides with the geometric center of the motor main body structure, the central axes of the torque output shafts of the remaining motor elements are symmetrical with respect to the geometric center of the motor main body structure. In this way, the motor elements of the matrix motor unit structure of the present application are arranged more compactly in the same plane, and the structure can be shared among the motor elements, so that the overall size and weight can be further reduced. The torque output shafts of the motor elements are connected through a transmission mechanism, so that a higher total output torque is obtained.

In one embodiment, the motor main body structure includes private stator yokes, private stator teeth arranged on the private stator yokes, private windings wound around the private stator teeth, public stator yokes, public stator teeth arranged on the public stator yokes, public windings wound around the public stator teeth, and several rotors corresponding to the private stator teeth and/or the public stator teeth, there is no magnetic circuit coupling of the private stator yokes, the private stator teeth, and the private windings with other motor elements, and there is magnetic circuit coupling of the public stator yoke, the public stator teeth, and the public windings with at least one of the motor elements.

In one embodiment, the motor main body structure further includes counteracting windings, and the counteracting windings are arranged on the public stator teeth and/or the public stator yoke.

In one embodiment, the motor main body structure further includes compensating windings, and the compensation windings are arranged on the private stator teeth and/or the private stator yokes.

In one embodiment, internal spaces of the motor elements are disconnected with each other, and the public stator yoke includes a first yoke formed by splicing two adjacent private stator yokes.

In one embodiment, internal spaces enclosed by stators of the motor elements are connected, and the public stator yoke includes second yokes used for achieving sharing of stator yokes of the motor elements.

In one embodiment, the public stator yoke further includes third yokes which are each arranged between rotors of two adjacent motor elements and not connected with the stators of the motor elements, and two opposite ends of each of the third yokes are provided with the public stator teeth facing the rotors of the corresponding motor elements, respectively.

In one embodiment, the motor main body structure further includes magnetic bridges, and two opposite ends of each of the magnetic bridges are connected with two third yokes, respectively;

or two opposite ends of each of the magnetic bridges are connected with one of the second yokes and one of the third yokes, respectively.

In one embodiment, the public stator yoke further includes fourth yokes which are each arranged between rotors of adjacent motor elements and not connected with the stators of the motor elements, the fourth yokes each have two first subsections opposite to the rotors of adjacent two motor elements and a second subsection opposite to the rotor of the motor element at a central position, and the two first subsections are connected with two opposite ends of the second subsection, respectively.

In one embodiment, the motor main body structure further includes magnetic flux modulation blocks, and the magnetic flux modulation blocks enclose the rotor of the motor element at the central position and correspond to the second subsections.

In a second aspect, the embodiments of the present application further provide a matrix motor, which includes the matrix motor unit structure described above.

The embodiments of the present application have the following beneficial effects: The matrix motor according to the present application is capable of obtaining a higher output torque upper limit on the basis of having the matrix motor unit structure described above.

### BRIEF DESCRIPTION OF DRAWINGS

FIG. 1 is a cross-sectional view of a matrix motor unit structure according to Embodiment 1 of the present application;

FIG. 2 is a composite view of coupling vectors of a B-phase winding of a second motor element of the matrix motor unit structure of FIG. 1;

FIG. 3 is a cross-sectional view of a matrix motor unit structure according to Embodiment 2 of the present application;

FIG. 4 is a cross-sectional view of a matrix motor unit structure according to Embodiment 3 of the present application;

FIG. 5 is a cross-sectional view of a matrix motor unit structure according to Embodiment 4 of the present application;

FIG. 6 is a schematic structural diagram of a matrix motor unit structure according to Embodiment 5 of the present application;

FIG. 7 is a front view of a matrix motor unit structure according to Embodiment 6 of the present application;

FIG. 8 is a front view of a matrix motor unit structure according to Embodiment 7 of the present application;

FIG. 9 is a front view of a matrix motor unit structure according to Embodiment 8 of the present application;

FIG. 10 is a cross-sectional view of a matrix motor unit structure according to Embodiment 9 of the present application;

FIG. 11 is a cross-sectional view of a matrix motor unit structure according to Embodiment 10 of the present application;

FIG. 12 is a cross-sectional view of a matrix motor unit structure according to Embodiment 11 of the present application;

FIG. 13 is a front view of a matrix motor unit structure according to Embodiment 12 of the present application;

FIG. 14 is a front view of a matrix motor unit structure according to Embodiment 13 of the present application;

FIG. 15 is a front view of a matrix motor unit structure according to Embodiment 14 of the present application;

FIG. 16 is a front view of a matrix motor unit structure according to Embodiment 15 of the present application;

FIG. 17 is a cross-sectional view of a matrix motor unit structure according to Embodiment 16 of the present application;

FIG. 18 is a cross-sectional view of a matrix motor unit structure according to Embodiment 17 of the present application;

FIG. 19 is a cross-sectional view of a matrix motor unit structure according to Embodiment 18 of the present application.

Reference numerals in the drawings having the following meanings:

100, matrix motor unit structure; 10, motor main body structure; 10a, motor element; 11, private stator yoke; 12, private stator tooth; 13, private winding; 14, public stator yoke; 15, public stator tooth; 16, public winding; 17, rotor; 21, counteracting winding; 22. compensating winding; 141, first yoke; 142, second yoke; 143, third yoke; 30, magnetic bridge; 144, fourth yoke; 14a, first subsection; 14b, second subsection; 40, magnetic flux modulation block; 18, public permanent magnet; and 19, private permanent magnet.

### DETAILED DESCRIPTION OF THE EMBODIMENTS

The embodiments of the present application are described in detail below, and the examples of the embodiments are shown in the drawings, throughout which identical or similar reference numerals represent identical or similar elements or elements having identical or similar functions. The embodiments described below with reference to the drawings are exemplary and are intended to explain the present application, rather than being construed as limiting the present application.

In the description of the present application, it should be understood that the terms “length”, “width”, “upper”, “lower”, “front”, “rear”, “left”, “right”, “vertical”, “horizontal”, “top”, “bottom”, “inner”, “outer”, and the like indicate orientations or positional relationships based on those shown in the drawings, which is merely for the convenience of describing the present application and simplifying the description, rather than indicating or implying that the apparatus or element referred to must have a specific orientation, be constructed and operate in the specific orientation, so it cannot be understood as a limitation to the present application.

In addition, the terms “first” and “second” are used herein for descriptive purposes only and should not be construed as indicating or implying relative importance or implicitly indicating the number of technical features described. Therefore, features defined with “first” or “second” may explicitly or implicitly include one or more of the features. In the description of the present application, unless otherwise specifically defined, “a plurality of” means two or more than two.

In the present application, unless otherwise clearly specified and defined, the terms “mount”, “interconnect”, “connect”, “fix”, and the like should be understood in their broad senses. For example, “connect” may be “fixedly connect”, “detachably connect” or “integrally connect”; “mechanically connect”, and “electrically connect”; or “directly interconnect”, “indirectly interconnect through an intermediate”, “the connection between the interiors of two elements”, or “the interaction between two elements”. For those of ordinary skill in the art, the specific meanings of the aforementioned terms in the present application can be understood according to specific conditions.

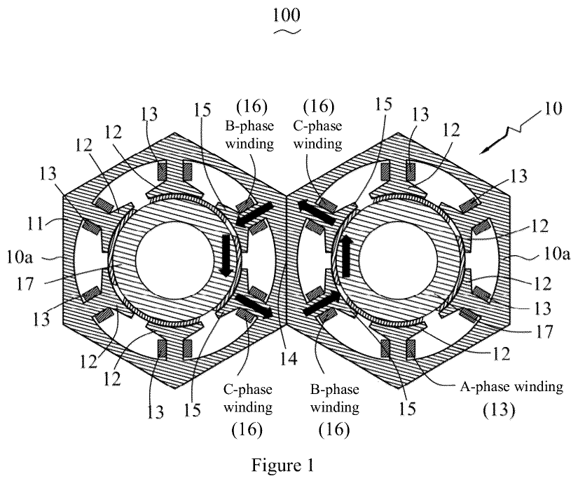

Referring to FIG. 1 and FIG. 3 to FIG. 6, in a first aspect, provided is a matrix motor unit structure 100 according to embodiments of the present application, which includes at least two motor elements 10a. The motor elements 10a are connected in an array form in a same plane and form a motor main body structure 10 by enclosure, so that central axes of torque output shafts of the motor elements 10a are symmetrical with respect to a geometric center of the motor main body structure 10. It can be understood that the contour of the motor main body structure 10 is symmetrical, so that in the case that the motor elements 10a output a torque, the overall structure is stressed symmetrically, so as to meet the requirement of stable output. The geometric center of the motor main body structure 10 may be the center of a circle, the center of gravity, or an intersection point of diagonal lines of the structure. On the basis of the above, the motor elements 10a are connected in the array form in the same plane. In this case, the connection may be a fixed connection, such as welding and integral molding, or a detachable connection, such as a threaded connection, a snap-in connection, and a plug-in connection. In the case that the connection is made, a part of the structure is shared among the motor elements 10a, so that the overall size of the motor main body structure 10 can be smaller, and the overall weight can be lighter to obtain a higher torque density and thus a higher output torque upper limit value.

In addition, it also includes the case that, among the motor elements 10a in the same plane, the central axis of the torque output shaft of one of the motor elements 10a coincides with the geometric center of the motor main body structure 10, so that except for the central axis of the torque output shaft of the motor element 10a, the central axes of the torque output shafts of the remaining motor elements 10a are symmetrical with respect to the geometric center of the motor main body structure 10.

Exemplarily, as shown in FIG. 1, in a same arrangement plane, the contours of the motor elements 10a are regular hexagons, and stator sides of two regular-hexagon motor elements 10a are connected, that is, the motor elements are arranged in a parallel array mode, so that the contour of the assembled motor main body structure 10 is the two regular hexagon, and the geometric center of the motor main body structure 10 is the center of the two regular hexagon.

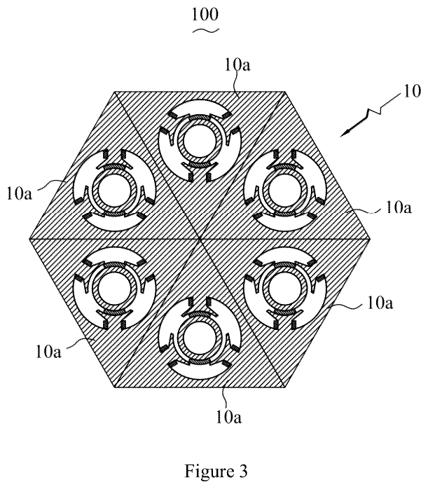

Exemplarily, as shown in FIG. 3, in a same arrangement plane, the contours of the motor elements 10a are equilateral triangles, and stator sides of six regular-hexagon motor elements 10a are connected, that is, the motor elements are arranged in an annular array mode, so that the contour of the assembled motor main body structure 10 is a regular hexagon, and the geometric center of the motor main body structure 10 is the center of the regular hexagon.

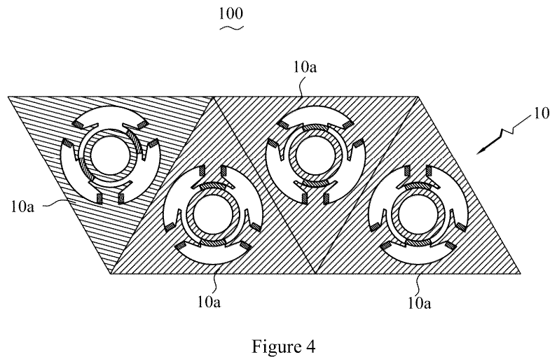

Exemplarily, as shown in FIG. 4, in a same arrangement plane, the contours of the motor elements 10a are equilateral triangles, and stator sides of four equilateral-triangle motor elements 10a are connected in sequence, that is, the motor elements are arranged in an array mode of parallel, sequential, and alternate arrangement, so that the contour of the assembled motor main body structure 10 is a parallelogram, and the geometric center of the motor main body structure 10 is located at an intersection point of diagonal lines of the parallelogram.

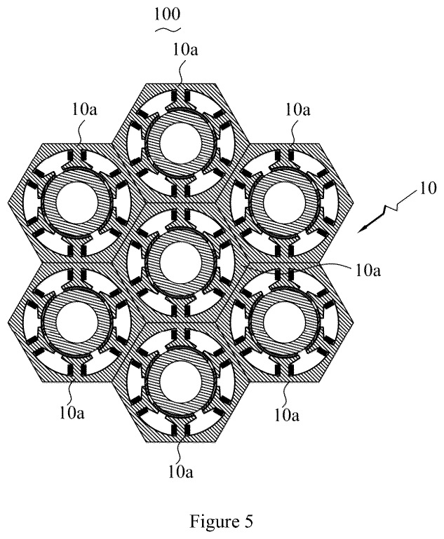

As shown in FIG. 5, in a same arrangement plane, the contours of the motor elements 10a are regular hexagons, stator sides of six motor elements 10a described above are connected, that is, the motor elements are arranged in an annular array mode, so that the contour of the assembled motor main body structure 10 is an octadecagon, and a central axis of the torque output shaft of the remaining one motor element 10a is located at the center of the octadecagon.

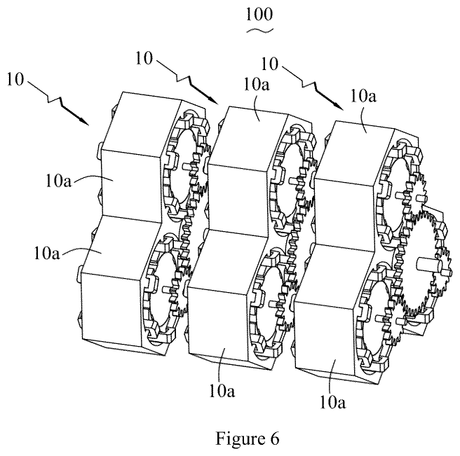

Exemplarily, as shown in FIG. 6, a matrix motor unit structure 100 may consist of two or more motor main body structures 10. As shown in the figure, the matrix motor unit structure 100 is formed by stacking three motor main body structures 10 in a direction perpendicular to an arrangement direction of the motor main body structures 10, then an output shaft is provided at a geometric center of each of the motor main body structures 10, and the output shafts are connected.

Provided is a matrix motor unit structure 100 according to the present application, which includes two or more motor elements 10a. In this case, the motor elements 10a are capable of operating independently, and the motor elements 10a are connected in an array form in a same plane to form a motor main body structure 10. The motor main body structure 10 has a geometric center, that is, the contour of the motor main body structure 10 is symmetrical, so that central axes of torque output shafts of the motor elements 10a are symmetrical with respect to the geometric center of the motor main body structure 10. Alternatively, in the case that the central axis of the torque output shaft of one of the motor elements 10a coincides with the geometric center of the motor main body structure 10, the central axes of the torque output shafts of the remaining motor elements 10a are symmetrical with respect to the geometric center of the motor main body structure. In this way, the motor elements 10a of the matrix motor unit structure 100 of the present application are arranged more compactly in the same plane, and the structure can be shared among the motor elements 10a, so that the overall size and weight can be further reduced. The torque output shafts of the motor elements 10a are connected through a transmission mechanism, so that a higher output torque is obtained.

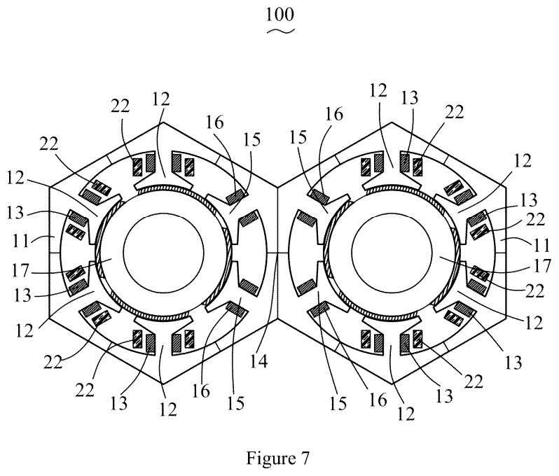

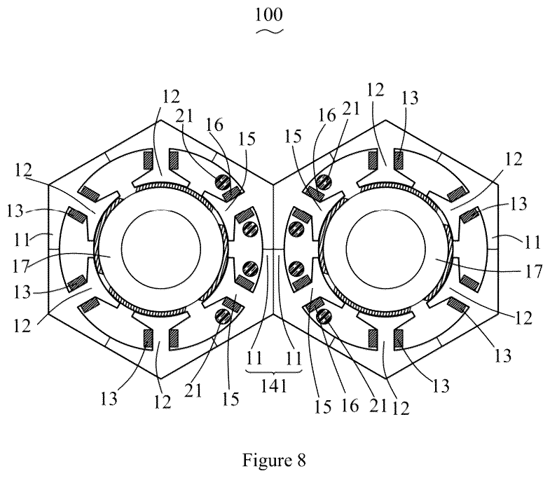

Referring to FIG. 7 and FIG. 8, the motor elements 10a themselves include a stator portion and a rotor portion. However, in the case that the motor elements 10a are assembled into the corresponding motor main body structure 10 in the same plane, the stator portions of adjacent motor elements 10a are private or public. The private stator portions and the public stator portions are defined as follows:

The motor main body structure 10 includes private stator yokes 11, private stator teeth 12, private windings 13, a public stator yoke 14, public stator teeth 15, public windings 16, and several rotors 17. In this case, the number of the rotors 17 corresponds to the number of the motor elements 10a, there is no magnetic circuit coupling of the private stator yokes 11, the private stator teeth 12, and the private windings 13 with other motor elements 10a, and there is magnetic circuit coupling of the public stator yoke 14, the public stator teeth 15, and the public windings 16 with at least one of the motor elements 10a. The magnetic circuit coupling is a phenomenon that magnetic fields are superposed on corresponding windings or stator teeth after the energization of two adjacent motor elements 10a, which generally occurs on the stators and has little influence on the rotors 17. Therefore, the type of the rotors 1 can be adjusted according to the use requirement, for example, to a permanent magnet synchronous motor rotor, an induction motor rotor, a DC brushless motor rotor, or the like. The private stator teeth 12 are arranged on the private stator yokes 11, and the private windings 13 are wound around the private stator teeth 12. The public stator teeth 15 are arranged on the public stator yoke 14, and the public windings 16 are wound around the public windings 16 on the public stator teeth 15.

Exemplarily, as shown in FIG. 1, in the case that two regular-hexagon motor elements 10a with six slots and four poles are spliced together, their magnetic fields at a certain moment are obtained. Specifically, the left motor element 10a in FIG. 1 is a first motor element, the right motor element 10a is a second motor element, and a B-phase winding and a C-phase winding of the first motor element are coupled with a B-phase winding and a C-phase winding of the second motor element, that is, a magnetic field generated by the C-phase winding of the first motor element enters the B-phase winding of the second motor element, and a magnetic field generated by the C-phase winding of the second motor element enters the B-phase winding of the first motor element. In this case, for the B-phase winding and the C-phase winding of each of the first motor element and the second motor element, there is not only the magnetic field of its own motor element but also the magnetic field of the other motor element flowing through them. Therefore, the motor teeth with the coupling phenomenon are the public stator teeth 15, the windings with the coupling phenomenon are the public windings 16, and the motor yoke with the coupling phenomenon is the public stator yoke 14; and far away from a coupling position of the two motor elements, the motor teeth without the coupling phenomenon are the private stator teeth 12, the motor windings without the coupling phenomenon are the private windings 13, and the motor yokes without the coupling phenomenon are the private stator yokes 11.

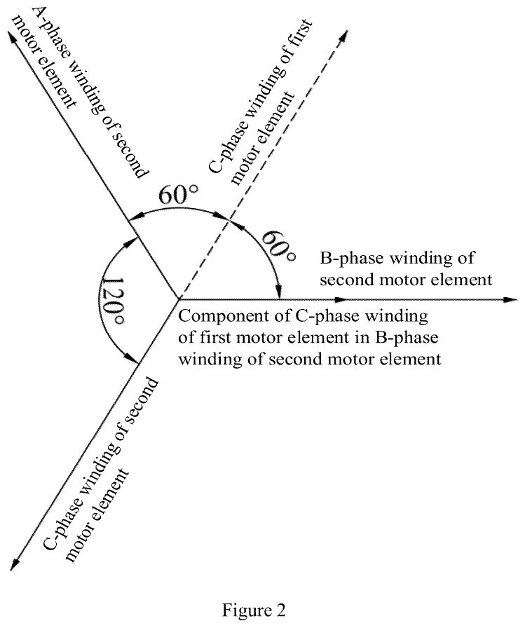

Exemplarily, as shown in FIG. 1 and FIG. 2, in the case that two regular-hexagon motor elements 10a with six slots and four poles are spliced together (in this case, it is assumed that magnetic poles of the rotors 17 of the two motor elements 10a each coincide with one corresponding A-phase, that is, the rotors 17 are in an aligned state), the magnetic field flowing through the public stator teeth 15 and the public windings 16 is enhanced or weakened due to the magnetic circuit coupling between the motor elements 10a. In this way, the magnetic fields of the public stator teeth 15 and the public windings 16, and the private stator teeth 12 and the private windings 13 in the motor main body structure 10 are unequal, and thus a torque ripple and an imbalance of magnetic pull of the entire motor main body structure 10 are caused. Specifically, as shown in FIGS. 1 and 2, FIG. 2 is a vector composite diagram of coupled magnetic fields of the public windings 16 of the two motor elements 10a in FIG. 1. The left motor element 10a in FIG. 1 is a first motor element, the right motor element 10a is a second motor element, the magnetic field of the C-phase winding of the first motor element (i.e., the public winding 16) is in a direction towards the outside of the first motor element, and simultaneously towards the inside of the second motor element (that is, the magnetic field of the C-phase winding of the first motor element flows into the B-phase winding of the second motor element (i.e., the public winding 16)), which is opposite to the case that the magnetic field of the C-phase winding of the second motor element is in a direction towards the outside of the second motor element, that is, there is a 180° current phase difference in space. Moreover, because the magnetic field of the B-phase winding of the second motor element exceeds the magnetic field of the C-phase winding by 120° in current phase, the direction of the magnetic field of the C-phase winding of the first motor element is spatially different from the direction of the magnetic field of the B-phase winding of the second motor element by a phase angle of 120°-180°=−60°, that is, the spatial phase angle between the B-phase winding of the second motor element and the C-phase winding of the first motor element is less than 90°. Therefore, the magnetic circuit coupling phenomenon enhances the magnetic fields flowing through the public windings 16 and the public stator teeth 15, and in the case of the angle of greater than 90°, the magnetic fields flowing through the public windings 16 and the public stator teeth 15 are weakened.

In order to balance unbalanced magnetic fields of the public stator teeth 15 and the public windings 16, and the private stator teeth 12 and the private windings 13 in the motor main body structure 10, additional windings can be arranged. Specifically, counteracting windings may be added at the public stator teeth 15 and the public stator yoke 14 of the motor main body structure 10, or compensating windings may be added at the private stator teeth 12 and the private stator yokes 11 of the motor main body structure 10.

Specifically, referring to FIG. 8, in one embodiment, the motor main body structure 10 further includes counteracting windings 21, and the counteracting windings 21 are arranged on the public stator teeth 15 and/or the public stator yoke 14. It can be understood that a current of a certain magnitude and phase is introduced into the counteracting windings 21, so that the magnetic fields generated by the counteracting windings 21 can change the magnitude or phase of the magnetic fields flowing through the public stator teeth 15 or the public stator yoke 14, thereby counteracting the coupling effect.

Alternatively, specifically, referring to FIG. 7, in another embodiment, the motor main body structure 10 further includes compensating windings 22, and the compensating windings 22 are arranged on the private stator teeth and/or the private stator yokes 11. It can be understood that a current of a certain magnitude and phase is introduced into the compensating windings 22, so that the magnetic fields generated by the compensating windings 22 can change the magnitude or phase of the magnetic fields flowing through the private stator teeth 12 or the private stator yoke 11, thereby compensating for the coupling effect.

Specifically, as shown in FIG. 8, in one embodiment, internal spaces of the motor elements 10a are independent of each other, that is, internal spaces of the motor elements 10a are not connected. In this case, the public stator yoke 14 includes a first yoke 141 formed by splicing two adjacent private stator yokes 11. It can be understood that the first yoke 141 is formed by splicing private stator yokes 11.

Exemplarily, in the case that two regular-hexagon motor elements 10a with six slots and four poles are spliced together, FIG. 2 is a vector composite diagram of the coupled magnetic fields of the public windings 16 of the two motor elements 10a in FIG. 1, wherein the left motor element 10a is a first motor element, the right motor element 10a is a second motor element, a component of a C-phase winding (public winding 16) of the first motor element in a direction perpendicular to a B-phase winding (public winding 16) of the second motor element exactly counteracts a component of a C-phase winding of the second motor element in a direction perpendicular to a B-phase winding of the first motor element. Therefore, there is no or only a very small amount of magnetic fields flowing through the public stator yoke 14 where the two motor elements 10a intersect. Based on this, the public stator yoke 14 of the two motor elements 10a can be removed, so that the motor weight is further reduced, and the torque density of the motor main body structure 10 is further improved.

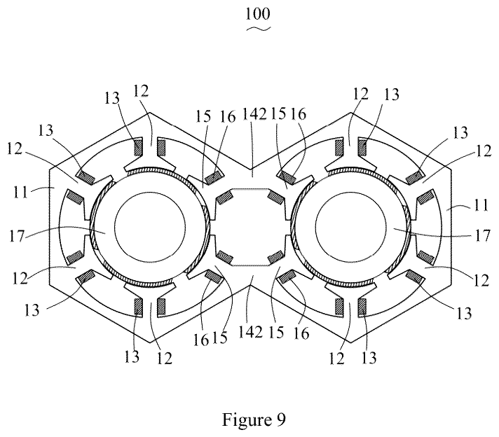

Specifically, referring to FIG. 9, in one embodiment, internal spaces enclosed by the stators of the motor elements 10a are in connection, that is, a stator portion shared by the motor elements 10a is removed, so that the internal spaces are connected. Although a public portion is removed, in terms of the structure, a stator portion connecting two adjacent motor elements 10a may be referred to as a public stator yoke 14, that is, in this case, the public stator yoke 14 includes second yokes 142 used for achieving sharing of stator yokes of the motor elements 10a.

Exemplarily, as shown in FIG. 9, in the case that two regular-hexagon motor elements 10a with six slots and four poles are spliced together, after the public stator portion is removed, yokes for achieving the connection of the two motor elements 10a are the second yokes 142 of the public stator yoke 14.

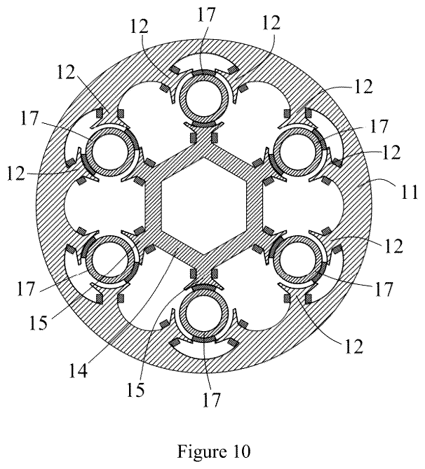

Referring to FIG. 10 to FIG. 12, in one embodiment, the public stator yoke 14 may be further eliminated for further weight reduction of the connected motor elements 10a. For example, in the case that six equilateral-triangle motor elements 10a with three slots and two poles are spliced together, the contour of the motor main body structure 10 may be modified from the original regular hexagon shown in FIG. 3 to a circular shape shown in FIG. 10. Meanwhile, the shape of the internal public stator yoke 14 of the motor main body structure 10 is modified to add more hollow spaces and change the shape of the original public stator yoke 14, so that the weight of the motor main body structure 10 is further reduced under the condition of magnetic circuit closure is satisfied; moreover, the number of turns of the windings can be increased in the added internal space, so that the torque density of the motor main body structure is further improved.

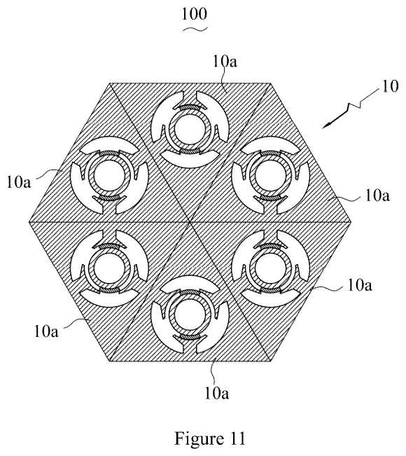

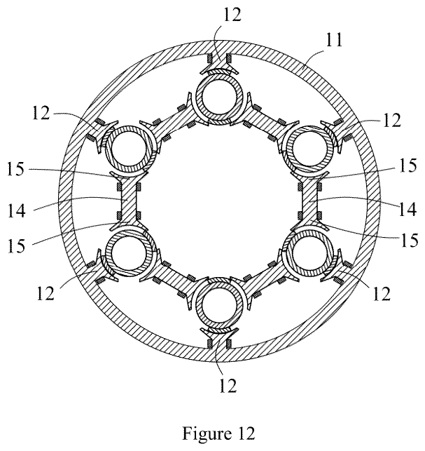

Exemplarily, as shown in FIGS. 11 and 12, in the case that six equilateral-triangle motor elements 10a with six slots and two poles are spliced together, the contour of the main body structure may also be modified from the original regular hexagon shown in FIG. 11 to a circular shape shown in FIG. 12. Meanwhile, the shape of the internal public stator yoke 14 of the motor main body structure 10 is modified to add more hollow spaces and change the shape of the original public stator yoke 14.

In summary, the central axes of the torque output shafts of the motor elements 10a of the motor main body structure 10 in the above embodiments are all symmetrical with respect to the geometric center of the motor main body structure 10.

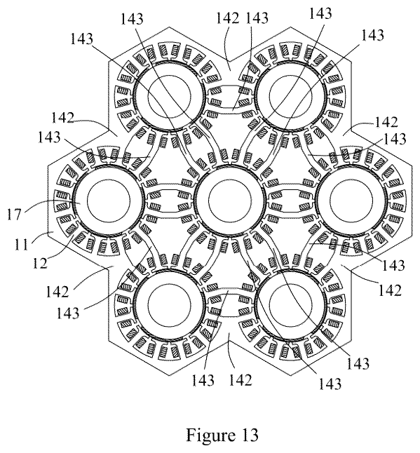

For example, as shown in FIGS. 13, 14, 15, and 16, in other embodiments, the central axis of the torque output shaft of one motor element 10a coincides with the geometric center of the current motor main body structure 10, while the central axes of the torque output shafts of the remaining motor elements 10a are symmetrical with respect to the geometric center of the motor main body structure 10.

Specifically, referring to FIG. 13, in order to further reduce the weight of the motor main body structure 10 described above, the stator of the motor element 10a in the central position may be removed, that is, the internal space of the motor element 10a is in connection with the space of the remaining motor elements 10a, and in order to achieve the magnetic circuit closure of the motor element 10a at the central position, the public stator yoke 14 further includes third yokes 143 which are each arranged between the rotors 17 of two adjacent motor elements 10a and not connected with the stators of the motor elements 10a, and two opposite ends of each of the third yokes 143 are provided with the public stator teeth 15 facing the rotors 17 of the corresponding motor elements 10a, respectively. In this case, the third yokes 143 can be independently arranged, with additional support structures used for supporting and limiting, and meanwhile, the third yokes can be replaced to facilitate later maintenance.

Exemplarily, as shown in FIG. 13, in the case that six regular-hexagon motor elements 10a with six slots and four poles are spliced to form a main body portion of the motor main body structure 10, and then a seventh motor element 10a is arranged at the central position of the motor main body structure 10, a closed magnetic circuit is formed between the rotor 17 of the motor element 10a at the center and the rotors 17 of the remaining motor elements 10a by using the third yokes 143. In addition, as the internal space of the motor main body structure 10 is gradually removed, the magnetic circuit closure between the motor elements 10a which are not at the center and are in an adjacent state can be achieved by using the third yokes 143.

Public stator teeth 15 and public windings 16 may also be arranged on the third yokes 143 while achieving the magnetic circuit closure among the motor elements 10a. Moreover, the shape of the third yokes 143 may be adjusted according to the degree of commonality of the third yokes 143. As shown in the figure, in this embodiment, the third yokes 143 are strip-shaped, and the public stator teeth 15 and the public windings 16 may be arranged at opposite ends of the third yokes.

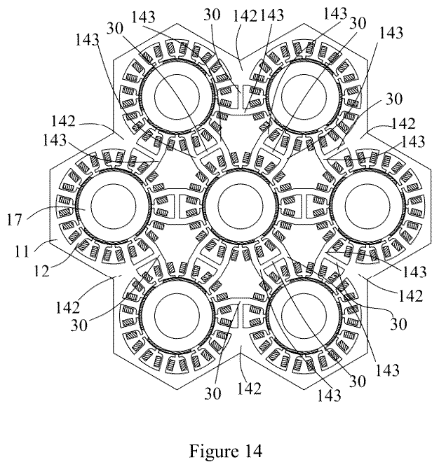

Referring to FIG. 14, in one embodiment, the motor main body structure 10 further includes magnetic bridges 30, and two opposite ends of each of the magnetic bridges 30 are connected with two third yokes 143, respectively. In this case, the magnetic bridges 30 serve to achieve connection between the same phases of adjacent motor elements 10a, thereby increasing the torque of the entire motor main body structure 10. In this case, the material of the magnetic bridges 30 is the same as that of the third yokes 143.

Exemplarily, as shown in FIG. 14, in the case that six regular-hexagon motor elements 10a with six slots and four poles are spliced to form a main body portion of the motor main body structure 10, and then a seventh motor element 10a is arranged at the central position of the motor main body structure 10, a closed magnetic circuit is formed between the rotor 17 of the motor element 10a at the center and the rotors 17 of the remaining motor elements 10a by using the third yokes 143, and meanwhile, the same phases between adjacent motor elements 10a can be connected through the magnetic bridges 30, so as to achieve the purposes of shortening the magnetic circuit and improving the torque.

Alternatively, as shown in FIG. 14, two opposite ends of the magnetic bridges 30 are connected with one of the second yokes 142 and one of the third yokes 143, respectively.

Alternatively, as shown in FIG. 14, in the same motor main body structure 10, two opposite ends of a part of the magnetic bridges 30 are connected with two third yokes 143, respectively, and two opposite ends of the remaining magnetic bridges 30 are connected with one of the second yokes 142 and one of the third yokes 143, respectively.

The number of poles and slots of the motor elements 10a may be the same or different in the same motor main body structure 10 according to actual use requirements. Referring to the figure, in this embodiment, the number of poles and the number of slots of the motor elements 10a of the motor main body structure 10 are different. Specifically, the public stator yoke 14 further includes fourth yokes 144 which are each arranged between the rotors 17 of the adjacent motor elements 10a and not connected with the stators of the motor elements 10a, the fourth yokes 144 each have two first subsections 14a opposite to the rotors 17 of the adjacent two motor elements 10a and a second subsection opposite to the rotor 17 of the motor element 10a at the central position, and the two first subsections 14a are connected with two opposite ends of the second subsection, respectively. It can be understood that the second subsection is the key to adjusting the number of poles and slots of the motor element 10a at the central position, for example, by changing the length of the second subsection 14b or by arranging windings at the corresponding second subsection 14b.

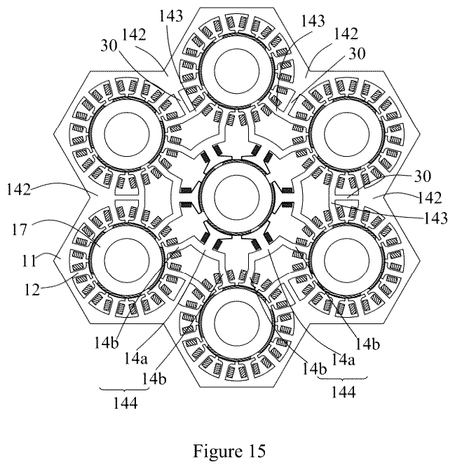

Exemplarily, as shown in FIG. 15, in the case that six regular-hexagon motor elements 10a with six slots and four poles are spliced to form a main body portion of the motor main body structure 10, and then a seventh motor element 10a is arranged at the central position of the motor main body structure 10, a closed magnetic circuit is formed between the rotor 17 of the motor element 10a at the central position and the rotors 17 of the remaining motor elements 10a by using the fourth yokes 144, and meanwhile, the length of the second subsection 14b in the fourth yokes 144 is adjusted, so that the number of poles and slots of the motor element 10a at the central position can be adjusted.

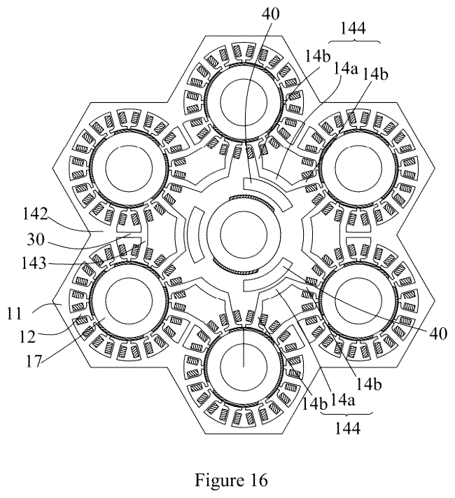

Referring to FIG. 16, in this embodiment, the motor main body structure 10 further includes magnetic flux modulation blocks 40, and the magnetic flux modulation blocks 40 encloses the rotor 17 of the motor element 10a at the central position and correspond to the second subsections 14b. It can be understood that the magnetic flux modulation blocks 40 are capable of coupling the magnetic fields generated by the public windings 16 around the motor element 10a at the central position, thereby achieving an output of the torque of the motor element 10a at the central position, that is, the magnetic flux modulation blocks 40 can replace the stator teeth and windings.

Exemplarily, as shown in FIG. 16, in the case that six regular-hexagon motor elements 10a with six slots and four poles are spliced to form a main body portion of the motor main body structure 10, and then a seventh motor element 10a is arranged at the central position of the motor main body structure 10, a closed magnetic circuit is formed between the rotor 17 of the motor element 10a at the central position and the rotors 17 of the remaining motor elements 10a by using the fourth yokes 144, and meanwhile, the magnetic flux modulation blocks 40 correspond to the second subsections 14b in the fourth yokes 144. The number of the magnetic flux modulation blocks 40 is half of the sum of the number of poles of the motor elements 10a in the outer circle and the number of poles of the motor element 10a at the central position.

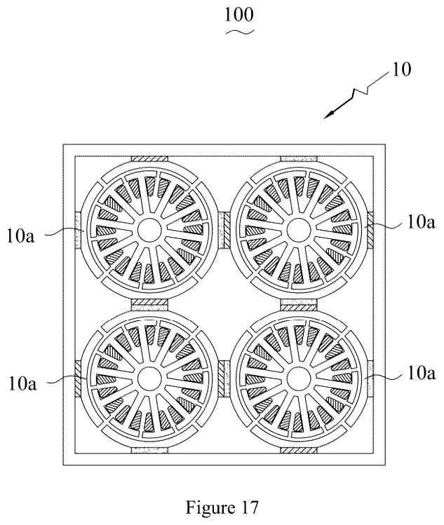

Referring to FIG. 17 to FIG. 19, in a second aspect, provided is a matrix motor according to embodiments of the present application, which includes the matrix motor unit structure 100 described above.

The matrix motor according to the present application is capable of obtaining a higher output torque upper limit on the basis of having the matrix motor unit structure 100 described above.

Exemplarily, as shown in FIG. 17, the matrix motor may be a DC matrix motor, and similarly, the matrix motor unit structure 100 is a DC matrix motor unit structure.

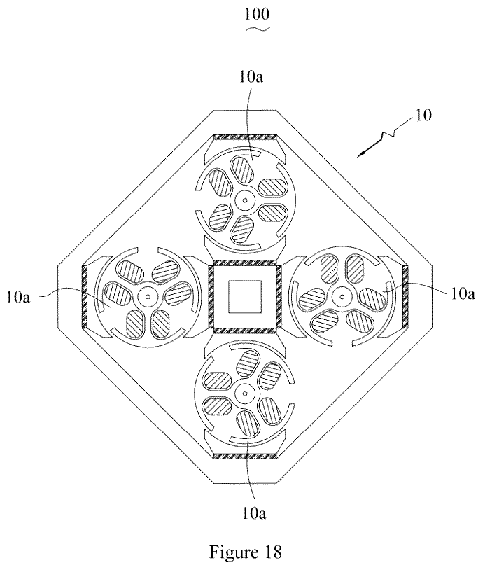

Exemplarily, as shown in FIG. 18, the matrix motor may be a two-pole DC matrix motor, and similarly, the matrix motor unit structure 100 is a two-pole DC matrix motor unit structure.

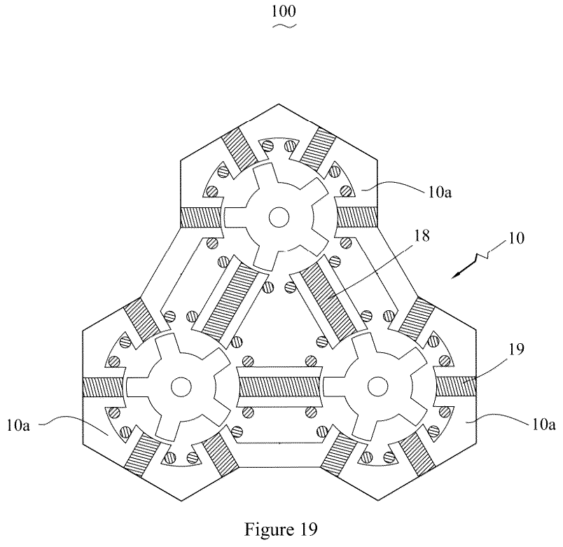

Exemplarily, as shown in FIG. 19, the matrix motor may be a flux-switching matrix motor, and similarly, the matrix motor unit structure 100 is a flux-switching matrix motor unit structure. In addition, the switching matrix motor unit structure 100 further includes a public permanent magnet 18 and an private permanent magnet 19.

The above description is only the preferred embodiments of the present application and should not be taken as limiting the present application, and any modifications, equivalents, improvements and the like that are made within the spirit and principle of the present application should be included in the protection scope of the present application.

What is claimed is:

1. A matrix motor unit structure, comprising at least two motor elements, wherein the motor elements are connected in an array form in a same plane and form a motor main body structure, the motor main body structure comprises private stator yokes and public stator yokes, there is no magnetic circuit coupling of the private stator yokes with other side motor elements, and there is magnetic circuit coupling of the public stator yoke with at least one of the motor elements.

2. The matrix motor unit structure according to claim 1, wherein the motor main body structure comprises private stator teeth arranged on the private stator yokes, private windings wound around the private stator teeth, public stator teeth arranged on the public stator yokes, public windings wound around the public stator teeth, and several rotors corresponding to the private stator teeth and/or the public stator teeth, there is no magnetic circuit coupling of the private stator teeth and the private windings with other side motor elements, and there is magnetic circuit coupling of the public stator teeth and the public windings with at least one of the motor elements.

3. The matrix motor unit structure according to claim 1, wherein the motor main body structure further comprises counteracting windings, and the counteracting windings are arranged on the public stator teeth and/or the public stator yokes.

4. The matrix motor unit structure according to claim 3, wherein the motor main body structure further comprises compensating windings, and the compensating windings are arranged on the private stator teeth and/or the private stator yokes.

5. The matrix motor unit structure according to claim 3, wherein internal spaces of the motor elements are disconnected with each other, and the public stator yoke comprises the first yoke formed by splicing two adjacent side private stator yokes.

6. The matrix motor unit structure according to claim 3, wherein internal spaces enclosed by stators of the motor elements are in connection, and the public stator yoke comprises second yokes used for achieving sharing of stator yokes of the motor elements.

7. The matrix motor unit structure according to claim 6, wherein the public stator yoke further comprises third yokes which are each arranged between rotors of adjacent two side motor elements and not connected with the stators of the motor elements, and two opposite ends of each of the third yokes are provided with the public stator teeth facing the rotors of the corresponding motor elements, respectively.

8. The matrix motor unit structure according to claim 7, wherein the motor main body structure further comprises magnetic bridges, and two opposite ends of each of the magnetic bridges are connected with two side third yokes, respectively;
or two opposite ends of each of the magnetic bridges are connected with one of the second yokes and one of the third yokes, respectively.

9. The matrix motor unit structure according to claim 6, wherein the public stator yoke further comprises fourth yokes which are each arranged between rotors of adjacent side motor elements and not connected with the stators of the motor elements, the fourth yokes each have two first subsections opposite to the rotors of adjacent two side motor elements and a second subsection opposite to the rotor of the motor element at the central position, and the two first subsections are connected with two opposite ends of the second subsection, respectively.

10. The matrix motor unit structure according to claim 9, wherein in the case that six regular-hexagon motor elements with six slots and four poles are spliced to form a main body portion of the motor main body structure, and then a seventh motor element is arranged at the center position of the motor main body structure, a closed magnetic circuit can be formed between the rotor of the motor element at the central position and the rotors of the remaining motor elements by using the fourth yokes.

11. The matrix motor unit structure according to claim 9, wherein the motor main body structure further comprises magnetic flux modulation blocks, and the magnetic flux modulation blocks enclose the rotor of the motor element at the central position and correspond to the second subsections.

12. The matrix motor unit structure according to claim 1, wherein central axes of torque output shafts of the motor elements are symmetrical with respect to a geometric center of the motor main body structure.

13. The matrix motor unit structure according to claim 12, wherein the geometric center of the motor main body structure can be the center of a circle or an intersection point of diagonal lines of the structure.

14. The matrix motor unit structure according to claim 12, wherein the matrix motor unit structure is formed by stacking two or more motor main body structures in a direction perpendicular to an arrangement direction of the motor main body structures.

15. The matrix motor unit structure according to claim 12, wherein the motor elements are connected in the array form in the same plane, and the motor elements are connected in a fixed connection or detachable connection mode.

16. The matrix motor unit structure according to claim 15, wherein among the motor elements in the same plane, the central axis of the torque output shaft of one of the motor elements coincides with the geometric center of the motor main body structure, so that except for the central axis of the torque output shaft of the motor element, the central axes of the torque output shafts of the remaining motor elements are symmetrical with respect to the geometric center of the motor main body structure.

17. The matrix motor unit structure according to claim 12, wherein in a same arrangement plane, the contours of the motor elements are regular hexagons, and stator sides of two regular-hexagon motor elements are connected, that is, the motor elements are arranged in a parallel array mode.

18. The matrix motor unit structure according to claim 12, wherein in a same arrangement plane, the contours of the motor elements are equilateral triangles, and stator sides of six regular-hexagon motor elements are connected, that is, the motor elements are arranged in an annular array mode; or stator sides of the four equilateral-triangle motor elements are connected in sequence, that is, the motor elements are arranged in an array mode of parallel, sequential, and alternate arrangement.

19. The matrix motor unit structure according to claim 12, wherein in a same arrangement plane, the contours of the motor elements are regular hexagons, and stator sides of six motor elements are connected, that is, the motor elements are arranged in an annular array mode.

20. A matrix motor, comprising the matrix motor unit structure according to claim 1.
